(19) United States
(12) Patent Application Publication
(10) Pub. No.: US 2005/0279386 A1
(43) Pub. Date: Dec. 22, 2005

(54) Glove bag adapted for use on high temperature piping and method of installing inspection port on asbestos insulated pipe

(76) Inventor: Howard Wall, Houston, TX (US)

Correspondence Address: EGBERT LAW OFFICES, 412 MAIN STREET, 7TH FLOOR, HOUSTON, TX, 77002, US

(21) Appl. No.: 10/873,948

(22) Filed: Jun. 21, 2004

(51) Int. Cl. B08B 3/02

(52) U.S. Cl. 134/21; 134/42; 134/104.2; 134/198; 134/182; 134/201

(57) ABSTRACT

A glovebag apparatus suitable for use in high temperature environments without permitting any environmental contaminants to escape is disclosed. The bag utilizes a vacuum pump to pull ambient temperature cooling air into the system at a volume sufficient to keep the working temperature inside the apparatus at temperatures low enough to assure the integrity of the bag material. The cooling air inflow is filtered to ensure containment of any airborne contaminants inside the bag. Also disclosed is an in-situ method for installing an inspection port through asbestos-laden insulation on high temperature pipes, without allowing the release of contaminants, through use of the high temperature glovebag disclosed herein.

### I. BACKGROUND OF THE INVENTION

One of the most effective thermal insulators known is asbestos. Asbestos is the name of a group of minerals that occur naturally as fibers and are used in certain industries. However, asbestos exposure causes lung cancer. The fibers tend to break easily into particles that can float in the air and stick to clothes. When the particles are inhaled, they can lodge in the lungs, damaging cells and increasing the risk for lung cancer. Workers who have been exposed to asbestos have a risk of developing lung cancer that is 3 to 4 times greater than that for workers who have not been so exposed.

Fortunately, asbestos readily adsorbs water and, hence free asbestos particles can be removed with a thorough washing. Effective asbestos abatement procedures require full sealed-barrier protection for all abatement workers and further requires that the particles be secured from contaminating the air. This leads to one of two scenarios for abatement: First (and far more difficult) workers must be completely enclosed in an air-tight suit with filtered air inlets for breathing and the area be thoroughly washed down after the removal of the asbestos. The run-off water must be collected and sealed. Alternatively, the area being abated can be thoroughly sealed and the abatement work be performed remotely, with the workers either using robotic devices or glove bag technology.

One of the more common uses of asbestos in the past has been for pipe insulation in large chemical, manufacturing and utility facilities. Standard procedures enclose the asbestos-containing pipe insulation in a sealed glove bag which protects the environment from accidental release and allows the insulation to be safely replaced in sections.

Unfortunately, the glove bags used are made of thermoplastic and rapidly deteriorate when exposed to heat. Currently approved glove bag abatement procedures have an upper limit on the temperature of the abatement environment of 150° F. Asbestos insulated pipes hotter than this limit cannot be abated without shutting down and cooling off the pipes, which is extremely expensive.

An object of this invention is to provide a thermoplastic glove bag which can be made to work in the abatement of asbestos insulation in pipes at temperatures in excess of 150° F. without melting and becoming unusable. A further object of this invention is to develop a procedure for using a thermoplastic glove bag to abate asbestos insulation in environments where piping being abated is operating at temperatures above 150° F. A further object is to show a method of using the high-temperature glove bag for installing a non-asbestos containing inspection port on an asbestos insulated pipe.

### II. BRIEF SUMMARY OF THE INVENTION

This invention makes use of the technique of forced-air cooling and adapts it to use in high temperature glove bags. The bag has both a filtered air intake port and a vacuum port. This allows the glove bag to be held at a pressure slightly below ambient in order to contain any contaminant in the event of an accidental breach of bag integrity, while at the same time removing heat through a constant stream of filtered, ambient temperature air. Throughout the remainder of this document, asbestos containing material shall be referred to using the acronym ACM.

### III. BRIEF DESCRIPTION OF THE SEVERAL VIEWS OF THE DRAWING

FIG. 1. Is a view of a section of piping with a glove bag attached. The bag contains filtered intake port, a vacuum port, a wash-water port and a sealed bag containing tools and material to use in the glove bag procedure.

FIG. 2. Is a cross-sectional view of an insulated pipe showing the pipe itself (2), the ACM insulation (4), a section of non-ACM (58) with an inspection port (60) cut into the non-ACM.

FIG. 3. Is a side view of the insulated pipe with a section of non-ACM insulation (58) installed containing an inspection port (60).

FIG. 4. Is a side view of an insulated pipe showing a strip of metal lagging (8) around the pipe and a removable metal inspection plate (70) covering the inspection port shown (60).

FIG. 5. Shows the glove bag after the procedures described herein are completed with the wash-water port (46) and the filtered intake port (44) removed and taped over. FIG. 5 also shows one glove arm (56) sealed off (48) with tools (72) inside and the vacuum-sealed bottom of the bag (50) containing the contaminant removed in the procedure.

FIG. 6. Shows the glove bag after all asbestos abatement procedures are complete but immediately prior to removal from the pipe.

### IV. DRAWINGS

See included sheets.

### V. DESCRIPTION OF THE PREFERRED EMBODIMENT

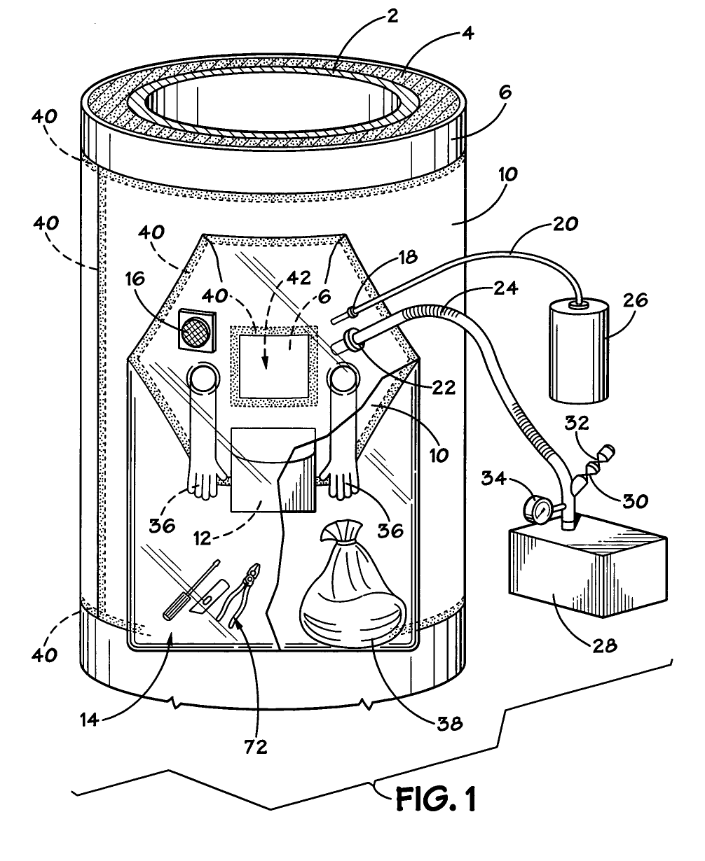

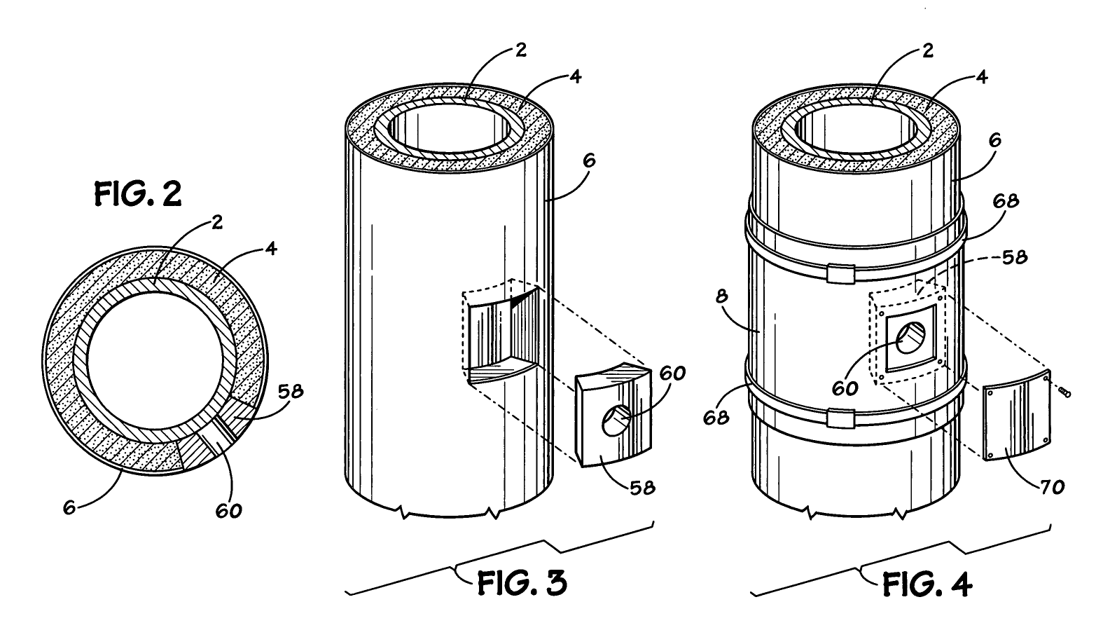

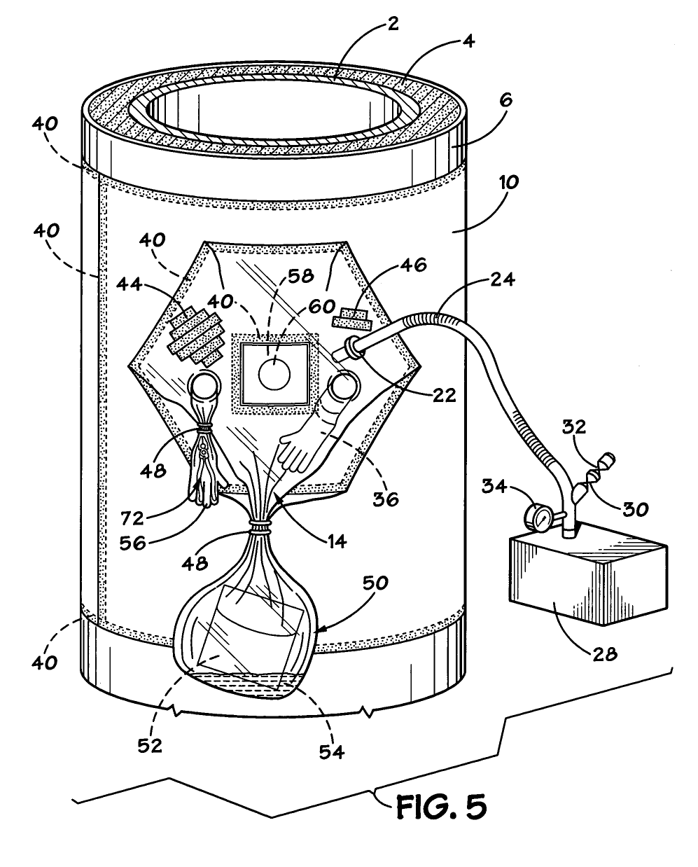

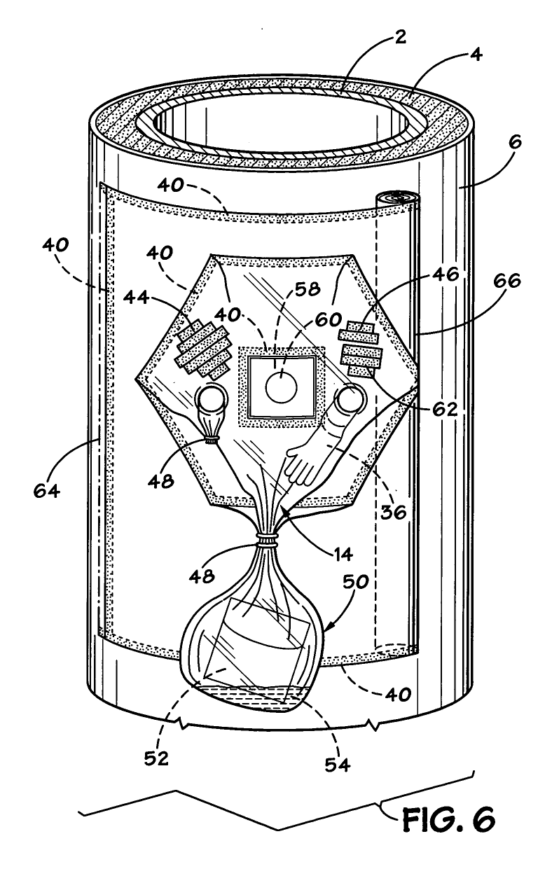

In the preferred embodiment, (shown in FIGS. 1, 5 and 6) a pipe (2), containing an ACM insulation (4) and covered by an insulation lagging (6) has the glove bag attached as below. The area to be abated is covered by a heat resistant wrap (10) secured to the lagging by sealing tape (40). A glove bag (14) having sleeved work gloves (36) is attached to the heat resistant wrap (10) using more of the sealing tape (40). The glove bag (14) is provided with a HEPA air inlet filter (16), a wash-water port (18) thru which a water line (20) delivers water from a water pump (26). The glove bag further has a vacuum port (22) to which a HEPA vacuum Unit (28) is connected, said Vacuum Unit having a regulated vacuum control valve (30), a regulated vacuum non-return valve (32) and a negative pressure gauge (34). The glove bag (14), prior to attachment to the insulated pipe (6), has loaded within it the tools (72) needed for the procedure, a heat resistant collection bag (12) to contain removed contaminant and a sealed bag containing non-ACM insulation (38).

The operator follows the procedure detailed below:

1. Lagging (6) on pipe insulation (4) in area to be abated will be cleaned.

2. A sheet of heat resistant wrapping (10) with a working porthole (42) is secured around the pipe.

3. A heat resistant collection bag (12) is secured to the heat resistant wrapping (10) directly below the area of pipe which is to have the inspection porthole (60) installed.

4. A Glovebag (14) is positioned directly over the heat resistant wrapping (10) and sealed using sealing tape (40).

5. A HEPA vacuum (28) shall be attached and the pressure inside the glove bag (14) shall be regulated to just below ambient pressure.

6. Within the sealed Glovebag (14), an opening is cut in the pipe insulation.

7. Small debris and asbestos dust resulting from the cutting process is collected by the HEPA vacuum (28).

8. The pieces of ACM insulation removed from the pipe are vacuumed and wetted, then placed inside the Heat Resistant Collection Bag (12).

9. Non ACM insulation (58) containing an inspection porthole (60) is removed from its sealed bag (38) and installed in the newly cut opening.

10. The perimeter (transition between Non-ACM insulation and ACM insulation) of the new insulation is sealed with a heat resistant, non-ACM sealant.

11. The Heat Resistant Collection Bag (12) containing ACM is sealed, detached from the Heat Resistant Wrap (10) and placed in the bottom of the Glovebag (14).

12. The inside surfaces of the Glovebag are rinsed with the wetting nozzle (18).

13. The tools (72) used in the process are held in one of the Gloves (36) and the sleeve is inverted (pulled inside-out).

14. The sleeve containing the tools is sealed (48) and cut free from the glove bag for future use or transport to decontamination unit.

15. The intake port (16) and wetting nozzle (18) port are sealed (44) & (46) and the regulated vacuum pressure is then used to collapse the Glovebag (50).

16. The bottom of the Glovebag (14), containing The Heat Resistant Collection Bag (12), wash water (54) and debris is sealed (48).

17. The vacuum intake hose (24) is sealed and removed from the Glovebag and the vacuum intake hole (22) in the Glovebag is sealed (62).

18. The Heat Resistant Wrapping (10) wrapped around the pipe is cut at the cut line (64), then, with the Glovebag (14) attached, is removed as one unit, rolling the Glovebag and Heat Resistant Wrapping onto itself.

19. The rolled heat resistant wrapping (10) and Glovebag (14) are put directly into a standard decontamination bag (not shown) and sealed.

20. Metal lagging (8) with an inspection port is matched up with the inspection port (60) in the non-ACM pipe insulation (58) and secured via banding (68).

21. A cover plate (70) is then secured over the inspection port (60).

1. An apparatus for maintaining a sealed work environment around high-temperature piping, said apparatus comprising:
a flexible sheet of non-permeable, heat-resistant material wrappably enclosing an insulated pipe;
means 1 for sealing said sheet to said pipe,
said sheet environmentally sealed to said insulated pipe at boundaries of said sheet using said means 1;
a flexible glovebag comprising
at least one glove sleeve fashioned through said glovebag to permit an operator to manipulate
at least one tool operably placed inside said glovebag,
a heat resistant collection bag to contain environmentally undesireable material, said collection bag operably placed inside said glovebag,
an air inlet port to admit cooling air inside said glovebag,
a vacuum port,
a vacuum device attached to a vacuum intake hose sealedly inserted into said glovebag through said vacuum port
means 2 for sealing said glovebag to said sheet.
said glovebag environmentally sealed to said sheet at edges of said glovebag using said means 2;

2. The apparatus of claim 1 further comprising a wash water port in said glovebag,
a water pump to deliver wash water inside said glovebag,
a water hose operably connected to said water pump and sealedly connected to said water port in said glovebag.

3. The apparatus of claim 1, said air inlet port comprising a sealedly attached HEPA filter.

4. The apparatus of claim 1, said vacuum device comprising a vacuum pump, a negative pressure gauge, a regulated vacuum non-return valve, and a regulated vacuum control valve

5. A method for installing an environmentally non-contaminating inspection porthole in high temperature insulated pipes, comprising the steps of:
a. a flexible, non-permeable sheet of heat resistant wrapping is wrappably secured around said insulated pipe;
b. a glovebag is positioned over said heat resistant wrapping and sealedly attached using a sealing means, said glovebag comprising at least one glove sleeve fashioned through said glovebag to permit an operator to manipulate at least one tool operably placed inside said glovebag; a heat resistant collection bag to contain environmentally undesireable material; said collection bag operably placed inside said glovebag; an air inlet port to admit cooling air inside said glovebag; a vacuum port and a wash water port;
c. a pressure regulated vacuum is attached to said glovebag through a vacuum port and the pressure inside said glove bag shall be regulated to just below ambient pressure;
d. within said glovebag, an opening is cut in said pipe insulation;
e. debris and dust resulting from said cutting is collected by said vacuum;
f. pieces of said insulation removed from said pipe are vacuumed through said vacuum port and wetted from said wash water port, then placed inside said collection bag;
g. non contaminating insulation containing an inspection porthole is removed from a sealed bag placed inside said glovebag and installed in said opening;
h. the perimeter of said non-contaminating insulation is sealed with a heat resistant, non-contaminating sealant;
i. said collection bag is sealed, detached from said heat resistant wrap and placed in the bottom of said glovebag;
j. the inside surfaces of said glovebag are rinsed through said wash water port;
k. said tools are placed in one of said glovebag gloves and said sleeve is inverted;
l. said inverted sleeve containing said tools is sealed and cut free from said glovebag;
m. said intake port and said wetting nozzle port are sealed & and pressure from said vacuum is used to collapse said glovebag;
n. the bottom of said glovebag, containing said collection bag, wash water and debris is sealed;
o. said vacuum intake hose is sealed and removed from said Glovebag and said vacuum intake hole in said Glovebag is sealed;
p. said heat resistant wrap around said pipe is cut at a cut line, then with said glovebag attached, is removed as one unit, rolling said glovebag and said heat resistant wrap onto itself;
q. said rolled heat resistant wrapping and said Glovebag are put directly into a standard decontamination bag and sealed;
r. metal lagging with an inspection port is matched up with said inspection port in said non-contaminated pipe insulation and secured;
s. a cover plate is secured over said inspection port.
